(19) United States
(12) Patent Application Publication
(10) Pub. No.: US 2023/0410698 A1
(43) Pub. Date: Dec. 21, 2023

(54) Illuminated Roll Up Sign

(71) Applicant: Dicke Safety Products, Inc., Downers Grove, IL (US)

(72) Inventor: Chad Clark, Salem, OR (US)

(21) Appl. No.: 17/841,263

(22) Filed: Jun. 15, 2022

(51) Int. Cl. G09F 13/04

(52) U.S. Cl. CPC G09F 13/0472; G09F 13/0468; G09F 13/0422; G09F 13/0431

(57) ABSTRACT

The present invention relates to an Illuminated Roll Up Sign. The traffic sign comprises a rollable sign member and a hand-held base member. The traffic sign of the present invention is light weighted and can be disassembled and packaged for the ease of storage and/or transportation.

### BACKGROUND OF THE INVENTION

Illuminated roll up signs are a great tool for controlling and directing the traffic. They keep drivers informed and people safe. However, there is a need in the art for hand-held signs that are easily and clearly legible even when there are visibility concerns due to, for example, weather conditions and/or dim light. The present invention addresses this unmet need.

### SUMMARY OF THE INVENTION

In one aspect, the invention provides a hand-held and illuminable traffic sign. In another aspect, the invention provides a kit comprising the traffic sign as presently claimed and a storage bag for packaging the same.

In certain embodiments, the traffic sign comprises a rollable sign member comprising at least one indicum; a plurality of lights arranged along the periphery of the rollable sign member; and a hand-held base member. In certain embodiment, the at least one indicium is selected from the group consisting of a color, a text character, a numeral, and a graphic

In certain embodiment, the hand-held base member comprises a column member, a mast for mounting the rollable sign member, at least one battery for illuminating the plurality of lights, and a power connector.

In certain embodiments, the rollable sign member is made from one selected from the group consisting of Non-Reflective Vinyl, Reflective Superbright™, Reflective Diamond Grade™, Reflective Marathon™.

In certain embodiments, the plurality of lights comprises light emitting diodes (LEDS).

In certain embodiments, the rollable sign member, upon unrolling, conforms to triangular, quadrilateral, pentagonal, hexagon, octagonal or circular shape.

In certain embodiments, the column member has circular, elliptical, or polygonal cross-sectional area. In certain embodiments, the column member may comprise a hollow interior portion. In certain embodiments, the column member with polygonal cross-sectional area comprises curved corners.

In certain embodiments, the mast is a hollow mast. In certain embodiments, the mast is not a hollow mast. In certain embodiments, the mast has circular, elliptical, or polygonal cross-sectional area. In certain embodiments, the mast comprises curved corners. In certain embodiments the mast may be detachable from the hollow column. In certain embodiments, the mast may comprise a plurality of telescoping portions.

In certain embodiment, the base member further comprises a power switch to “turn on” or “turn off” the plurality of lights.

In certain embodiments the height of the base member can vary from about 2 feet to about 4 feet.

### BRIEF DESCRIPTION OF THE DRAWINGS

The following detailed description of preferred embodiments of the invention will be better understood when read in conjunction with the appended drawings. For the purpose of illustrating the invention, there are shown in the drawings embodiments which are presently preferred. It should be understood, however, that the invention is not limited to the precise arrangements and instrumentalities of the embodiments shown in the drawings.

FIGS. 1A-1B show the rollable sign member (101) unrolled and mounted on the base member (102) in accordance with embodiments of the present invention. Additionally, FIG. 1A shows the power controller switch (105) and FIG. 1B shows the power plug (106) connected to the power controller (110).

FIG. 2 shows that base member (102) comprises a hollow column member (203) and a mast (201). The base member (102) also comprises a slot (202) to receive the mast (201) in accordance with embodiments of the present invention.

FIG. 3 depicts the rollable sign member 101 in its rolled-up conformation.

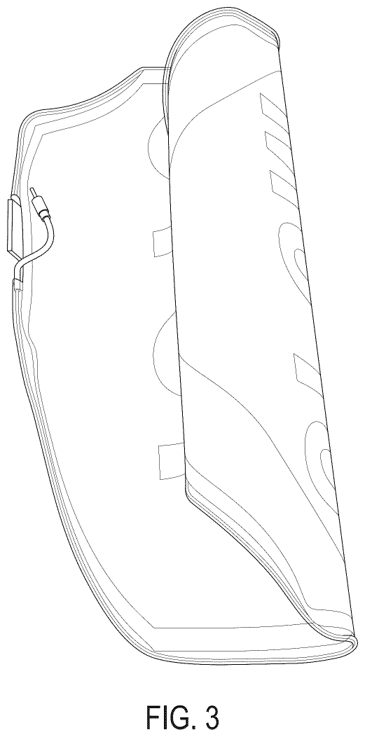

FIG. 4 is a perspective bottom view of the base member (102) comprising hollow column (203).

### DETAILED DESCRIPTION OF THE INVENTION

### Definitions

Unless defined otherwise, all technical and scientific terms used herein have the same meaning as commonly understood by one of ordinary skill in the art to which this invention belongs. Although any materials similar or equivalent to those described herein can be used in the practice or testing of the present invention, the preferred materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, or ±0.1% from the specified value, as such variations are appropriate to perform the disclosed methods.

Ranges: throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

### Traffic Sign

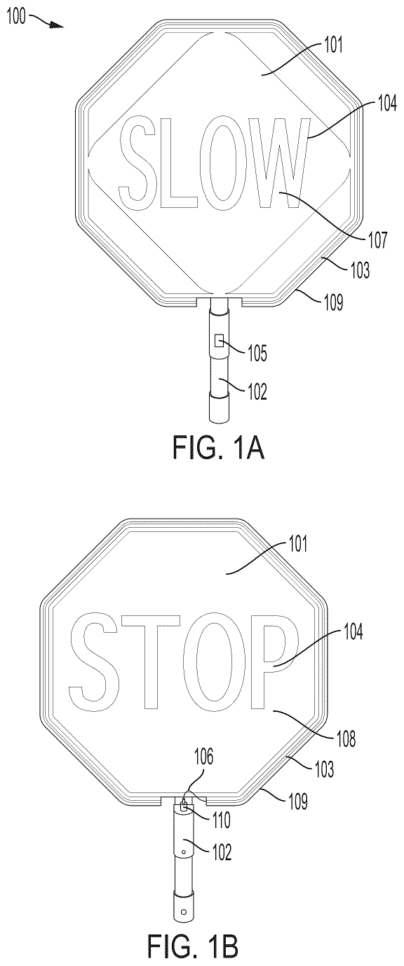

As shown in FIGS. 1A and 1B, in one aspect, the present invention provides an illuminable traffic sign (100) that can be rolled and packaged either for storage or for ease of portability. In another aspect, the invention provides a kit comprising the traffic sign as presently claimed and a storage bag for packaging the traffic sign.

In certain embodiments, the traffic sign comprises a rollable sign member (101) and a base member (102). In certain embodiments, the rollable sign member (101) comprises two surfaces, a front surface (107) and a rear surface (108). In certain embodiments, at least one surface of the rollable sign member comprises an indicium (104). In certain embodiments, the indicium (104) is one selected from the group consisting of a color, at least one text character, at least one numeral, a graphic, and any combination thereof.

In certain embodiments, the rollable sign member (101) is made from a lightweight, durable, waterproof, and flexible material. In certain embodiments, the rollable sign member (101) comprises a reflective material. In certain embodiments, the rollable sign member (101) comprises a non-reflective material. In certain embodiments, the rollable sign member (101) is made from, for example, Non-Reflective Vinyl, Reflective Superbright™, Reflective Diamond Grade™, or Reflective Marathon™.

In certain embodiments, when unrolled, the rollable sign member (101) assumes triangular, quadrilateral, pentagonal, hexagon, octagonal or circular geometry. In certain embodiments, when unrolled, the rollable sign member (101) conforms to an octagonal shape. In certain embodiments, when unrolled, the rollable sign member (101) conforms to a hexagonal shape.

In certain embodiments, the rollable sign member (101) further comprises a plurality of lights (103) for illuminating the traffic sign when needed. In certain embodiments, the plurality of lights (103) comprises lights arranged along the periphery of the traffic sign (100). In certain embodiment, the plurality of lights (103) is encased within a transparent casing (109) made of a material suitable for protecting the plurality of lights against external climate change, vibration, shock, etc. In certain embodiments, the transparent casing is made from a flexible, light-weight, and waterproof material. In certain embodiments, the plurality of lights (103) comprises Light Emitting Diodes (LEDs). The LEDs may comprise any variety of colors and intensities. By way of example, the LED's may be arranged such that certain LEDs are outwardly facing from one surface, and certain other LEDs are outwardly facing from the opposed surface, and the color LEDs correspond to the respective surface. In certain embodiments, the rollable sign member (101) comprises a power plug (106) that can be connected to the power connector (110) for supplying power for illuminating the plurality of lights.

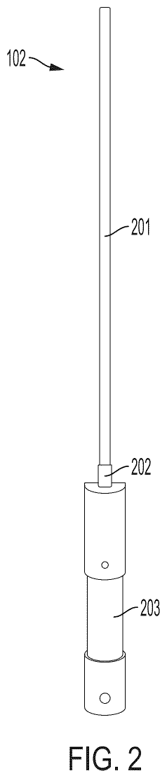

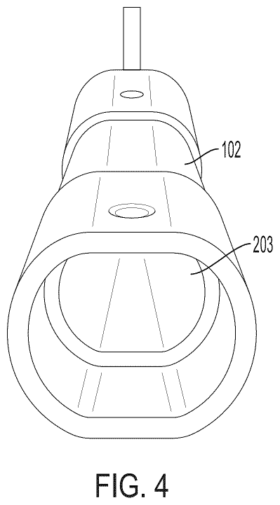

In certain embodiments, the base member (102) is a configured to be a hand-held base member and is as shown in FIG. 2. In certain embodiments, the base member (102) is made from light weight material such as, for example, plastic, carbon fiber, or aluminum. In certain embodiments, the base member (102) comprises a hollow column (203). In certain embodiments, the hollow column (203) has circular, elliptical, or polygonal cross-sectional area. In certain embodiments, the hollow column (203) comprises curved corners. In certain embodiments, the hollow column (203) does not comprise curved corners. In one embodiment, as shown in FIG. 4 the hollow column has an elliptical cross-sectional area with curved corners.

In certain embodiments, the base member (102) further includes a mast (201) and a slot (202) for attaching the mast (201) on which the sign member (101) can be mounted. In certain embodiments, when desired the mast (201) can be detached to disassemble the base member (102). In certain embodiments, the mast (201) is a hollow mast. In certain embodiments, the mast (201) is not a hollow mast. In certain embodiments, the mast (201) has circular, elliptical, or polygonal cross-sectional area. In certain embodiments, the mast (201) comprises curved corners (202). In certain embodiments, the mast (201) may not be detachable from the base member (102). In some embodiments, the mast (201) may comprise a plurality of telescoping portions that may be collapsed or extended.

In certain embodiments, the base member (102) further includes a power supply source. In certain embodiments, the power supply source may be a solar power supply source. In certain embodiments, the power supply source is a battery, which may be rechargeable or non-rechargeable. Although not shown, the base member may include a charging port operatively connected to the battery to enable charging thereof. In certain embodiments, the base member (102) further comprises a power connector (110) configured to receive the power plug (106). In certain embodiments, the base member comprises a power controller switch (105) for controlling the supply of power to the plurality of lights. In certain embodiments, the power controller switch (105) can be toggled to “on” position for illuminating the plurality of lights. In certain embodiments, the power controller switch can be configured to select a state for the plurality of lights, such as an active or “on” state, and an inactive or “off” state. In certain embodiments, the power controller switch may include other states, such as to cause the lights to flash intermittently. Although not shown it is the base member may also include an audio player configured to play a message, such as “stop” or “slow down.”

In certain embodiments, the height of the base member (102) can vary from about 2 feet to about 4 feet.

In certain embodiments, the traffic sign is light weight to allow for its use as a hand-held traffic sign. As shown in FIG. 4, the hollow column (203) is preferably configured to accept the end of a handle or extension pole or upright stand member. In some embodiments, the hollow column may include a connection means to attach to a handle or extension pole or upright stand member.

### Other Embodiments

The recitation of a listing of elements in any definition of a variable herein includes definitions of that variable as any single element or combination (or subcombination) of listed elements. The recitation of an embodiment herein includes that embodiment as any single embodiment or in combination with any other embodiments or portions thereof. The disclosures of each and every patent, patent application, and publication cited herein are hereby incorporated herein by reference in their entirety.

While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

1. A traffic sign comprising:
a rollable sign member comprising at least one indicium, wherein the at least one indicium is selected from the group consisting of a color, a text character, a numeral, and a graphic;
a plurality of lights arranged along the periphery of the rollable sign member; and
a hand-held base member, wherein the hand-held base member comprises:
a) a column member,
b) a mast for mounting the rollable sign member, and
c) a power connector adapted to connect to a power source

2. The traffic sign of claim 1, wherein the rollable sign member is made from one selected from the group consisting of Non-Reflective Vinyl, Reflective Superbright™, Reflective Diamond Grade™, Reflective Marathon™.

3. The traffic sign of claim 1, wherein the plurality of lights comprises light emitting diodes (LEDs).

4. (canceled)

5. The traffic sign of claim 1, wherein the column member comprises a hollow interior portion configured to accept an end of an extension member.

6. (canceled)

7. (canceled)

8. The street sign of claim 1, wherein the base member further comprises a power switch to cause the lights to be in a plurality of states including inactive, and constant active.

9. The street sign of claim 8, wherein the plurality of states further includes an intermittent active state.

10. (canceled)

11. A traffic sign comprising:
a rollable sign member comprising a first face having a first indicium and a second face having a second indicium, the first indicium comprising a stop sign, the second indicum comprising a slow sign;
a plurality of lights arranged along the periphery of the rollable sign member; and
a hand-held base member, wherein the hand-held base member comprises:
e) a column member including a hollow interior portion,
f) a mast for mounting the rollable sign member,
g) at least one power source for illuminating the plurality of lights,
h) a power connector, and
i) a power control adapted to cause the illuminating of the plurality of lights to be selected from a plurality of states.

12. The traffic sign of claim 11, wherein the column member comprises a hollow interior portion configured to accept an end of an extension member.

13. (canceled)

14. (canceled)

15. (canceled)
